(19) United States
(12) Patent Application Publication
(10) Pub. No.: US 2005/0175656 A1
(43) Pub. Date: Aug. 11, 2005

(54) Materials and methods for treating lumber and wood products

(76) Inventor: William Toreki, Gainesville, FL (US)

Correspondence Address: ELMAN TECHNOLOGY LAW, P.C., P. O. BOX 209, SWARTHMORE, PA, 19081-0209, US

(21) Appl. No.: 10/419,510

(22) Filed: Apr. 21, 2003

Related U.S. Application Data
(63) Continuation-in-part of application No. 09/965,740, filed on Sep. 28, 2001.
(60) Provisional application No. 60/374,543, filed on Apr. 21, 2002.

(51) Int. Cl. A01N 25/08

(52) U.S. Cl. 424/410

(57) ABSTRACT

Disclosed herein is a novel wood treatment that confers resistance to termites and other wood-boring insects, as well as resistance to fungi and other wood-attacking microbes. Specifically exemplified is a wood treatment that comprises treating wood with an antimicrobial composition that comprises a quaternary ammonium compound.

### CROSS-REFERENCE TO OTHER APPLICATIONS

This application is a continuation-in-part of application Ser. No. 09/965,740, filed Sep. 9, 2001, pending, and is also a continuation-in-part of application No. 60/374,543, filed Apr. 21, 2002, the priority of both of which is claimed under 35 USC § 120, whose teachings are incorporated by reference.

### BACKGROUND OF THE INVENTION

One of the most effective and widely used treatments for the preservation of lumber and other wood products against fungal decay and insect attack is a system based on chromated copper arsenate (CCA). However, the use of CCA as a wood treatment has been shown to have negative health and environmental effects (Kluger, J. “Toxic Playgrounds: Forts and Castles Made of Arsenic-treated Wood Last for Years, but Should Kids Be Playing on Them?” Time 158(2), p48-49 (2001); Brooks, Kenneth M. (2000). Assessment of the Environmental Effects Associated with Wooden Bridges Preserved with Creosote, Pentachlorophenol, or Chromated Copper Arsenate. Madison, Wis.: U.S. Department of Agriculture, Forest Service, Forest Products Laboratory. (FPL-RP-587); Hingston J A, Collins C D, Murphy R J, Lester J N. “Leaching of Chromated Copper Arsenate Wood Preservatives A Review”. Environmental Pollution 11(1), 53-66. (2001); Long, Cheryl “Arsenic Again Shown to Leach From Pressure Treated Wood”. Organic Gardening, 44(4), 18, (1997).) As a result, the US Environmental Protection Agency (EPA) has asked lumber manufacturers to undertake a voluntary phase-out of CCA usage (see: “Manufacturers to Use New Wood Preservatives, Replacing Most Residential Uses of CCA” (http://www.epa.gov/pesticides/citizens/cca_transition.htm). The primary toxic effects of CCA are associated with arsenic; however, it is known that chromium and copper salts also have adverse effects on environmental and human health (Timothy Townsend, et al. “Leaching and Toxicity of CCA-Treated and Alternative-Treated Wood Products, Florida Center for Solid and Hazardous Waste Management Report#01-XX (2001), see http://www.floridacenter.org/publications/Altchem_final_draft.pdf). Exposure to these toxic compounds can occur through direct contact during manufacture, shipping, or construction; or by incidental contact such as inhalation of sawdust or vapors released upon burning. Leaching of these toxic metals into the soil or groundwater is also a problem.

U.S. patent application Ser. No. 09/965,740 teaches the use of quaternary ammonium-containing polymers grafted onto cellulose substrates as absorbent antimicrobial surfaces. Cellulose is one of the principal components of wood. The method described in the above patent application is applicable to the treatment of wood in order to render it resistant to microbial attack. Evidence for the efficacy of this method for the prevention of decay by wood-destroying fungi is presented herein. It has also been found (unexpectedly) that wood treated in this manner is also resistant to destruction by termites.

Preservative treatment of wood is usually done by using pressure to force the liquid preservative solution into the pores of the wood. A vacuum may be applied prior to introduction of the treatment solution in order to increase penetration. The active agents (such as CCA) are generally dissolved in a solvent. The solutions are generally of low viscosity in order to facilitate penetration of the treatment. Treatments may be classified as waterborne, or oilborne. A useful summary of the various chemical systems, application methods, efficacy, and other considerations related to wood preservation is given in: Forest Products Laboratory. 1999. Wood handbook—Wood as an engineering material. Gen. Tech. Rep. FPL-GTR-113. Madison, Wis.: U.S. Department of Agriculture, Forest Service, Forest Products Laboratory. 463 p.

Arsenic-containing formulations, such as CCA, are waterborne treatments. Although most of the toxic chemical is retained in the treated wood for a long period of time, some leaching does occur since the toxic agents are water-soluble. Waterborne systems are generally preferable to solvent based (oilborne) preservative systems for economic reasons, but also because the oil-based solvent themselves must be considered as pollutants.

One of the most common oilborne wood preservative treatments is the coal-tar creosote system. This system is generally used for railroad crossties, dock pilings, and utility poles. Most people are familiar with the dark appearance and unpleasant odor of wood treated in this manner. Creosote vapor photosensitizes exposed skin. Timbers treated in this manner cannot be satisfactorily painted. Creosote is an EPA restricted-use pesticide. Toxic chemicals are released when this type of wood is burned.

Pentachlorophenol (penta) is another common oilborne preservative. It is applied to wood using petroleum-based solvents. It is an EPA restricted-use pesticide. It is toxic, and should not be used where human, plant, or animal contact is likely.

Copper napthenate is another oilborne preservative, and although it is not a restricted-use pesticide, it is toxic and should be handled accordingly.

Bis(tri-n-butyltin) oxide is another oilborne preservative. Organotin compounds are known to be highly toxic, and their use in marine applications has been banned.

Waterborne preservatives, other than arsenic-containing systems, have also been used for wood preservation. Many of these systems rely on the antimicrobial activity of metals such as chromium or copper. Chromium is known to be an extremely toxic pollutant, and it use is undesirable. Copper is a metal found in natural deposits and widely used in household plumbing materials. Copper is an essential nutrient, required by the body in very small amounts. However, if the level of contamination is above the MCL in water or food supply, then people exposed to it can be affected by stomach and intestinal distress, liver and kidney damage and anemia. (see, for instance: Toxicological Profile for Copper, December 1990 Update, Agency for Toxic Substances and Disease Registry, United States Public Health Service). Most of the contamination is due to copper mining and smelting operations and municipal incineration. As such, the use of copper in treated wood should be discouraged.

Didecyldimethylammonium chloride (DDAC), also called alkyl ammonium compound (AAC), is a water (and solvent)-soluble antimicrobial effective against fungi and insects. Unfortunately, it is water soluble, and thus will leach from treated lumber unless fixated by a stabilization method. It is used as a component of the ammoniacal copper quat (ACQ) preservative system. That system is undesirable for the reasons discussed above.

Grafting of various monomers onto wood to form wood-polymer composites is known (Robert M. Rowell, Robert Moisuk, John A. Meyer, “Wood Polymer Composites: Cell Wall Grafting With Alkylene Oxides and Lumen Treatments with Methyl Methacrylate”, Wood Science, Vol 15, No 2, 90-96 (October 1982)). Grafting occurs not just on the exterior of the wood, but also in the interior sections, onto the cell walls of the internal voids, or lumen. An alternative approach is bulk polymerization of nongrafted polymer within the internal lumen spaces. Rowell studied both these methods. Grafting was performed using propylene oxide and alkaline catalysis. Interlumenal bulk polymerization was carried out using crosslinked poly(methyl methacrylate), which led to a general improvement of the mechanical properties of the wood. Neither of these approaches was intended to prevent decay by insect or fungal attack.

Ibach and Rowell (Rebecca E. lbach and Roger M. Rowell, “Wood Preservation Based on In situ Polymerization of Bioactive Monomers: Part 1. Synthesis of Bioactive Monomers, Wood Treatments and Microscopic Analysis”, Holzforschung, Vol 55, No 4, 358-364 (2001)) investigated in situ polymerization of bioactive monomers within the cell voids of wood. Various compounds were studied including pentachlorophenolyl acrylate (PCPA), tributyl tin acrylate (TBTA), 8-hydroxyquinolyl acrylate (HQA). Some of these compounds afforded a moderate degree of fungal resistance; however, some of these monomers are quite toxic (PCPA and TBTA), none are commonly available (and thus expensive), and all require the use of organic solvents such as alcohol or acetone for pressure treatment. Since the polymers formed are insoluble in water, they should not leach from the wood under normal conditions; however, a high percentage of residual (toxic) monomer was found to be present, which could potentially migrate to the surface of the product. This required an additional processing step (leaching with acetone) to remove. The composites prepared by that method are not expected to be covalently bonded graft copolymers formed between wood and the bioactive monomer (polymer).

### SUMMARY OF THE INVENTION

The subject invention is based on the formation of composite or graft copolymer materials formed between wood and polymers that contain quaternary ammonium groups. In this process, an aqueous solution of quaternary monomer, catalyst or polymerization initiator, and (optionally) crosslinking agent is impregnated into the pores of the wood. Preferably, the wood or wood-containing product becomes fully saturated with said solution. Reaction of the catalyst causes polymerization of the monomer along with grafting to form covalently bonded wood/quaternary composites. The addition of crosslinking agent serves to increase the degree of branching of the polymer, thus providing additional bioactive function. Preferably, the impregnation of the wood to be treated is assisted by the appropriate application of vacuum and/or pressure. Heating may optionally be applied to the system in order to increase the rate of the polymerization reaction. A washing step may be employed after polymerization in order to remove soluble components such as quaternary homopolymer. Alternatively, or in addition, pre-formed antimicrobial polymer may be infused into the lumber to confer resistance to termite infestation, wood rot, microbial decay, or to confer other beneficial properties on the lumber. Conference of resistance to termites and microbes may also be produced by the presence of antimicrobial groups within the interstices of the wood without necessarily being bound to the wood structure.

The monomers used in the practice of this invention preferably contain polymerizable vinyl or allyl groups that can be polymerized by free radical polymerization. The monomers also contain quaternary ammonium groups in order to provide an antimicrobial effect. Quaternary ammonium compounds are known to show an antimicrobial effect against a wide variety of microorganisms including fungi, bacteria, and some viruses. It may not be expected that quaternary ammonium compounds would be toxic to termites and other wood-destroying insects. It is known, however, that the digestive process of termites relies heavily on the action of numerous microorganisms found in the termite gut.

The quaternary polymers utilized in the practice of this invention are of low toxicity. They also pose a very low risk for pollution and environmental concerns. Many of the polymers useful in the practice of this invention are widely used as flocculating agents in wastewater treatment.

Examples of some monomers useful in the practice of this invention are disclosed in application Ser. No. 09/965,740. Some catalysts that are useful in the practice of this invention include peroxides, azo compounds, and cerium (IV) salts, preferably those compounds that are soluble in aqueous solutions. Examples of some of these catalysts are: (2,2′-azobis(2-methylpropionamidine)dihydrochloride (V-50), hydrogen peroxide, sodium persulfate, and cerium(IV) ammonium nitrate.

It will be understood from this disclosure that wood in the form of lumber, wood-pulp, and wood-derived products may be treated to confer resistance to microbes, including but not limited to fungi, bacteria and the like, as well as to certain insects, such as termites, which may depend on the action of microbes in their digestion of wood-based foodstuffs. It will further be understood from the present disclosure that quaternary amine containing polymers may be formed in-situ, by provision of appropriate conditions for quaternary amine monomers to polymerize after being impregnated into the wood. Alternatively, or in addition, pre-formed quaternary amine containing polymer may be infused into the interstices of the wood. Where formed in-situ, the polymer is at least partially bonded to the cellulosic substrate of the wood. Where pre-formed, the polymer will take substantially longer to diffuse out of the wood than if quaternary amine monomers are used to protect the wood. Furthermore, other compounds may be included with the polymer in formulating an optimal composition for protecting wood. Inclusion of copper, chromium, organic antimicrobials and the like may be used to advantage in combination with the methods and products taught according to this invention. Utilization of this invention in combination with a product such as CCA may permit effective control of lumber decay, while at the same time vastly decreasing the amount of CCA needed to provide the same level of lumber protection heretofore only achievable using much higher levels of CCA.

Treatment of wood and lumber products according to this invention will provide significant protection against wood-destroying fungi and insects. It is also likely that mechanical properties of the wood will also be improved, particularly at high grafting levels. Representative examples of methods used in the practice of this invention are given below, along with supporting data to confirm anti-fungal and anti-termite efficacy.

### EXAMPLE 1

Yellow pine sapwood, and poplar boards were purchased at a local building supply store and cut into ¾ inch cubes. Growth ring density of the pine was approximately 4 to 6 rings per centimeter. Wood was stored indoors at room temperature for several days prior to treatment. Wood samples were dried to constant weight under vacuum to establish baseline conditions. The average weight of the pine blocks was 4.2 grams per block, while the average weight of the poplar blocks was 3.6 grams per block.

Approximately 42 blocks were treated in each run. For each run the blocks were placed into a 750 mL aluminum pressure vessel and evacuated for approximately 20 minutes. The treatment solution was introduced under vacuum and the blocks were allowed to soak for approximately 10 minutes. An overpressure of 200 psi of argon gas was applied to the vessel, held for several minutes, and then released slowly. The pressurization step was then repeated. The vessel was slowly vented, opened, and contents of the vessel were then transferred to a one-quart mason jar. The liquid in the jar was sparged with argon gas, and the jar was then sealed with an argon atmosphere inside. The jar was then placed into an oven at 70° C. overnight (approximately 18 hours).

After heating overnight, the jars were cooled, opened, and the blocks were removed and washed. Samples prepared using crosslinking agent had to be physically removed from the surrounding gelled polymer. Samples were washed in warm tap water for several days in order to remove any residual monomer or soluble quaternary homopolymer. This step is not a necessary part of this invention, but it was undertaken in order to allow an evaluation of the antimicrobial activity of the grafted copolymer without interference from soluble components. After washing, the samples were air-dried at room temperature overnight, and then dried with heating under vacuum until constant weight was obtained. The average weight of the blocks was calculated. The composition of the treatment solutions and the average weights of the treated blocks are presented in Table 1.

The monomer used was Ageflex FM1Q75MC ([2-(methacroyloxy)ethyl]trimethylammonium chloride, 75 wt % solution in water, Ciba Specialty Chemicals Corporation), also abbreviated as TMMC. Catalysts were either CAN (ammonium cerium(IV) nitrate), SPS (sodium persulfate), or V-50. Crosslinking agents were either SR344 (polyethylene glycol diacrylate, Sartomer Company), glycerol, or ethoxylated₁₅ trimethylolpropane triacrylate (SR 9035—Sartomer Company).

TABLE 1

| | wood | mono- | | | | |
|---|---|---|---|---|---|---|
| # | type | mer | catalyst | crosslinker | water | weight |
| 1A | pine | 100 mL | 5 g CAN | none | 400 mL | 4.4 g |
| 1B | poplar | 100 mL | 4 g CAN | none | 400 mL | 3.4 g |
| 2A | pine | 100 mL | 4 g CAN | 5 g SR344 + 2 g | 400 mL | 4.5 g |
| | | | | glycerol | | |
| 2B | poplar | 100 mL | 4 g CAN | 5 g SR344 + 2 g | 400 mL | 3.9 g |
| | | | | glycerol | | |
| 3A | pine | 150 mL | 5 g SPS | 20 g SR344 | 330 mL | 5.5 g |
| 3B | poplar | 150 mL | 5 g SPS | 20 g SR344 | 330 mL | 4.8 g |
| 4A | pine | 50 mL | 3 g CAN | 4 g SR344 + 2 g | 450 mL | 4.3 g |
| | | | | glycerol | | |
| 4B | poplar | 50 mL | 3 g CAN | 4 g SR344 + 2 g | 450 mL | 3.6 g |
| | | | | glycerol | | |

### EXAMPLE 2

Samples of wood treated as taught in Example 1 were inoculated with a white-rot wood destroying fungus, along with untreated controls. After 10 days incubation, the surface of untreated blocks was greater than 90% covered with a layer of fungal growth. The treated blocks were virtually free of any visible fungal growth. Photographs were taken of these samples in order to provide a permanent verification these experimental results. Samples of wood treated according to the above formulations were sent to The Mississippi Forest Products Laboratory at Mississippi State University for testing according to the AWPA Standard E10-91 “Standard Method of Testing Wood Preservatives by Laboratory Soil-Block Cultures”. The average weight loss of the treated wood blocks (4 different treatment levels), after exposure to four different wood-destroying fungi is summarized below:

| SPECIES | SAMPLE | Avg. Weight loss |
|---|---|---|
| G. trabeum | Untreated | −44.48% |
| ″ | Ret 1 | −37.71% |
| ″ | Ret 2 | −37.32% |
| ″ | Ret 3 | −0.86% |
| ″ | Ret 4 | −13.25% |
| P. placenta | Untreated | −40.07% |
| ″ | Ret 1 | −27.12% |
| ″ | Ret 2 | −26.90% |
| ″ | Ret 3 | −20.36% |
| ″ | Ret 4 | −0.26% |
| T. lilacino-gilva | Untreated | −54.21% |
| ″ | Ret 1 | −44.64% |
| ″ | Ret 2 | −44.40% |
| ″ | Ret 3 | −52.63% |
| ″ | Ret 4 | −0.91% |
| T. versicolor | Untreated | −73.88% |
| ″ | Ret 1 | −3.32% |
| ″ | Ret 2 | −16.02% |
| ″ | Ret 3 | −18.63% |
| ″ | Ret 4 | −0.45% |

The above data clearly indicates that the treatments were quite effective in reducing destruction of wood by fungi.

### EXAMPLE 3

Samples of wood treated in the manner described Example 1 were subjected to a modified version of the AWPA Standard E1-97, “Standard Method for the Laboratory Evaluation to Determine Resistance to Subterranean Termites”. Five jars containing pine blocks treated by the above process, and five jars containing untreated pine blocks were tested against termites (Reticulitermes flavipes). After 10 days, significant destruction of the untreated wood by insect activity was observed; whereas, the treated samples were completely intact with no evidence of insect activity. Samples of wood treated according to the above formulations were sent to The Mississippi Forest Products Laboratory at Mississippi State University for testing according of the AWPA Standard E1-97, “Standard Method for the Laboratory Evaluation to Determine Resistance to Subterranean Termites”. These results are summarized below.

| Termite species | SAMPLE# | Weight loss |
|---|---|---|
| Reticulitermes spp. | T-1 | 0.00% |
| ″ | T-2 | −0.07% |
| ″ | T-3 | −0.28% |
| ″ | T-4 | −1.31% |
| ″ | Untreated | −23.09 |
| Coptotermes formosanus | T-1 | −0.12% |
| ″ | T-2 | −0.80% |
| ″ | T-3 | −0.73% |
| ″ | T-4 | −0.83% |
| ″ | Untreated | −16.42% |

It can be seen that all four formulations were very effective in protecting wood against destruction by termites.

### EXAMPLE 4

In-situ Polymerization and Crosslinking Treatment of Southern Pine for Field Testing

The objective of this study was to evaluate the field performance of wood treated with several polymer systems disclosed and claimed herein.

Materials

Monomer-[2-(methacryloyloxy)ethyl]trimethyl ammonium chloride (TMMC); Initiators -2,2′-Azobis(2-methylpropionamidine)dihydrochloride (AZO) and sodium persulfate (SPS), Crosslinker-Ethoxylated trimethylolpropane triacrylate esters (SR9035)

Preparation of Treating Solution

Treating solutions were prepared by adding the monomer, initiator and crosslinker (in this order) into water. Special care was taken to ensure that each ingredient was completely dissolved before the next ingredient was added. Argon (Ar) gas was sparged into the solution to purge oxygen during the whole solubilization process. For each formulation, 3500 grams of solution were prepared. The components of each system are given in the following table.

Summary of the Monomer, Initiator and Crosslinker in the Treating Solutions

| Sample # | TMMC | AZO/SPS | SR9035 | Water |
|---|---|---|---|---|
| 1 | 154.0 | AZO: 15.0 | 39.0 | 3292.0 |
| 2 | 215.0 | AZO: 15.0 | 43.0 | 3227.0 |
| 3 | 312.0 | AZO: 15.0 | 52.0 | 3121.0 |
| 4 | 154.0 | SPS: 15.0 | 39.0 | 3292.0 |
| 5 | 215.0 | SPS: 15.0 | 43.0 | 3227.0 |
| 6 | 312.0 | SPS: 15.0 | 52.0 | 3121.0 |

Treatment

Thirty Fahlstrom stakes (0.16″×1.5″×10″) were vacuum-pressure treated using 15 minutes of 27″ Hg vacuum, vacuum fill, followed by 5 minutes of 100 psi pressure of Ar gas. Retentions were calculated based upon solution concentrations and weights before and after treatment. After treatments, samples were split into two groups. One group was placed into a plastic bag pre-purged with Ar gas and sealed. The other group was placed in a plastic bag without Ar purging and sealed. Both groups were stored overnight in an oven preset at 70° C. The treated samples were then taken out, air-dried and the ten stakes closest to the desired retention were selected and labeled for field exposure. Stakes were placed into ground contact exposure in Gainesville, Fla. and inspected annually for extent of fungal decay and/or termite attack following the procedure in AWPA Standard E7-01.

Evaluation of the Solution Stability

The solutions before and after treatment were sampled and placed in the lab at room temperature for stability evaluation. It was found that all solutions were cured and gelled after two days.

Results

Average results for decay and termite infestation were determined after approximately eight months in the ground. A perfect wood stake is firm and the corners are square. Minor softening in early wood corners or other trace decay and isolated shallow termite grazing is ignored. A decay grade of 10=sound, minimal decay; 9=trace decay to 3% of cross section; 8=3-10% decay; 7=10-30% decay; 6=30-50% decay; 4=50-75% decay; 0=failur. For termites: 10=sound, 1-2 small nibbles; 9=slight feeding −3% of cross section; 8=3-10% of cross section; 7=attach of 10-30% of cross section; 6=30-50%; 4=50-75% cross section attacked; 0=failure. Averages were taken for ten stakes per treatment:

| | | AVERAGE | | AVERAGE | |
|---|---|---|---|---|---|
| | RETEN- | DECAY | TERMITE | DECAY | TERMITE |
| SAMPLE # | TION | AIR CURED | | ARGON CURED | |
| 1 | 5.5 | 10 | 8.1 | 9.7 | 7.7 |
| 2 | 7.4 | 9.9 | 8.7 | 10 | 9.9 |
| 3 | 10.4 | 10 | 9.9 | 10 | 9.7 |
| 4 | 5.5 | 9.9 | 7.1 | 9.9 | 7.0 |
| 5 | 7.4 | 10 | 9.1 | 10 | 8.4 |
| 6 | 10.4 | 9.9 | 9.5 | 10 | 9.7 |
| CONTROL | 0 | 8.8 | 5.0 | 8.8 | 5.0 |

As can be seen, all treated samples improved resistance to termite attack as well as to decay. The degree of protection appeared to be correlated with the retention levels.

The teachings of all cited references are incorporated by reference to the extent they are not inconsistent with the teachings herein. It should be understood that the examples and embodiments described herein are for illustrative purposes only and that various modifications or changes in light thereof will be suggested to persons skilled in the art and are to be included within the spirit and purview of this application and the scope of the appended claims.

1. Wood or wood-containing product treated with an antimicrobial composition to confer increased resistance to termites and other wood-boring insects wherein said composition comprises a quaternary amine containing polymer.

2. The wood or wood-containing product of claim 1, wherein said antimicrobial composition comprises a quaternary ammonium compound, formed from polymerizable vinyl or allylic quaternary amine containing monomers.

3. The wood or wood-containing product of claim 1, wherein said wood or wood-based product is treated such that an antimicrobial composition is impregnated therein.

4. The wood or wood-based product of claim 1, wherein said wood or wood-based product is treated with an antimicrobial composition such that resistance to fungal attack is increased.

5. The wood or wood-based product of claim 1, wherein said wood or wood-based product is treated with an antimicrobial composition comprising a quaternary ammonium compound such that resistance to termite infestation is increased.

6. A method of treating wood or wood-containing product to confer resistance to fungus, bacteria, or wood-boring insects, or combinations thereof, comprising contacting said wood or wood-based product with an antimicrobial composition comprising polymerized or polymerizable quaternary amine monomers, under conditions such that the polymer is either preformed or is formed in-situ, and is substantially retained within the wood following such treatment.

7. The method of claim 6, wherein said antimicrobial composition comprises a quaternary ammonium compound comprising polymerized or polymerizable vinyl or allyl quaternary amine groups.

8. The method of claim 6 wherein said composition comprises a monomer and a catalyst, and whereby upon contacting said wood or wood-containing product, said composition polymerizes such that antimicrobial groups are impregnated into said wood or wood-containing product.

9. The method of claim 8, wherein said contacting comprises spraying, coating, infusing, dipping, or soaking.

10. The method of claim 9, wherein said contacting comprises soaking under pressure, vacuum, or in any sequence, pressure and vacuum.

11. A composition for treating lumber to retard lumber decay comprising polymerizable quaternary amine monomers when infused into lumber.

12. The composition according to claim 11 further comprising a polymerization initiator or catalyst.

13. The composition according to claim 12 further comprising a polymerizable cross-linker.

14. A lumber product comprising polymeric quaternary amine infused therein.

15. The lumber product according to claim 14 further comprising additional lumber preservative compounds.
